(19) United States
(12) Patent Application Publication
(10) Pub. No.: US 2010/0235232 A1
(43) Pub. Date: Sep. 16, 2010

(54) ADVERTISEMENT PROVIDING SYSTEM AND METHOD THEREOF

(76) Inventor: Jong-Hun Lee, Seoul (KR)

Correspondence Address: SHERR & VAUGHN, PLLC, 620 HERNDON PARKWAY, SUITE 320, HERNDON, VA, 20170, US

(21) Appl. No.: 12/676,822

(22) PCT Filed: Aug. 8, 2008
(86) PCT No.: PCT/KR2008/004647

§ 371 Date: Mar. 5, 2010

(30) Foreign Application Priority Data
Sep. 5, 2007 (KR) 10-2007-0089835
Dec. 13, 2007 (KR) 10-2007-0130239

(51) Int. Cl. G06Q 30/00; G06Q 10/00

(52) U.S. Cl. 705/14.43; 705/14.45

(57) ABSTRACT

The present invention relates to an advertisement providing system and a method thereof. The advertisement providing system of the present invention receives first contents registration information and second contents registration information for providing an advertisement from an advertisement provider, stores the received information, the first contents registration information including basic advertisement contents and the second contents registration information including additional advertisement contents that corresponds to the basic advertisement contents, and provides a stored web page and the basic advertisement contents to a user terminal. When receiving a user action on the basic advertisement contents for activating the additional advertisement contents from the user terminal, the advertisement providing system provides the additional advertisement contents to the user terminal. According to the present invention, an advertisement is provided by re-selling existing advertisement contents instead of providing a location-based basic advertisement, thereby increasing advertising efficiency with minimum expenses.

### TECHNICAL FIELD

The present invention relates to an advertisement providing system, and a method thereof. Particularly, it relates to an advertisement providing system that can provide second advertisement contents to a user by using basic advertisement contents on a web page, and a method thereof.

### BACKGROUND ART

In general, a method for displaying an advertisement of a sponsor (hereinafter also referred to as an advertisement provider) in a predetermined location on a web page (hereinafter also referred to as a web site) by selling the predetermined location to the sponsor is the most general method for providing an advertisement on-line.

Such an on-line advertising method includes a banner advertising method, a pop-up/pop-down advertising method, a user created contents (UCC) advertising method, a keyword search advertising method, a category search advertising method using a keyword, a brand search advertising method, and a cross media advertising method.

According to an advertising method using banner/pop-up pop-down/flash/UCC, an advertisement screen attached to a specific location of a web site is linked to a web site of a sponsor, and a range of contents provided in the specific location can be varied from general text to a motion picture so that location-based advertisement contents can be provided to a user without regard to a format of contents to be advertised.

According to the keyword search advertising method, advertisement contents are exposed on the basis of a searching result of a keyword input by the user and an advertisement matching the searching result is exposed on a specific location in a web page based on tendency of users so as to attract more users to a sponsor's site.

The category search advertising method is a kind of the keyword search advertising method, and exposes an advertisement on a specific location in a web page if the advertisement is included in a category of a product.

The brand search advertising method is a kind of the keyword search advertising method, and exposes an advertisement of a brand on a specific location in a web page if the brand is input as a keyword.

The cross media advertising method is based on interaction between off-line (e.g., TV, etc.) and on-line media to simultaneously increase advertising effects and brand power by exposing the same advertisement advertised through the off-line media to a specific location in a web page.

The conventional on-line advertising methods perform location-based advertising so that a web page lacks a resource (e.g., left/right side location in the web page, etc.) for providing advertisement contents to users. Particularly, many advertisements cannot be efficiently provided due to limited resource availability.

In addition, competition between sponsors for displaying advertisements with the limited resource availability increases advertising expenses of the sponsors.

The above information disclosed in this Background section is only for enhancement of understanding of the background of the invention and therefore it may contain information that does not form the prior art that is already known in this country to a person of ordinary skill in the art.

### DETAILED DESCRIPTION

### Technical Problem

The present invention has been made in an effort to provide an advertisement providing system that provides second advertisement contents to a user by using basic advertisement contents on a web page, and a method thereof.

In addition, the present invention provides an advertisement providing system that provides a series of the same second advertisement contents to a user by using basic advertisement contents on a web page, and a method thereof.

### Technical Solution

An exemplary advertisement providing system that provides an advertisement to a user terminal according to an embodiment of the present invention includes: a contents providing device that provides a web page and basic advertisement contents to the user terminal, provides additional advertisement contents to the user terminal in response to a user action on the basic advertisement contents for activating the additional advertisement contents, and collects action information for the user action, the action information including the number of exposures/clicks of the basic advertisement contents and the number of exposures/clicks of the additional advertisement contents; and an advertisement providing device that provides the basic advertisement contents and the basic advertisement contents to the contents providing device and performs a billing process for respective advertisement providers of the basic advertisement contents and the additional advertisement contents.

The advertisement providing device bills an advertisement provider with grades for the basic advertisement contents based on the number of exposures/clicks of basic advertisement contents included in the action information and stored information including a running period of the basic advertisement contents and a format of the basic advertisement contents, and bills an advertisement provider with grades for the additional advertisement contents based on the number of exposures/clicks of additional advertisement contents and stored information including a running period of the additional advertisement contents and a format of the additional advertisement contents.

An exemplary advertisement providing method of a system that provides an advertisement to a user terminal according to another embodiment of the present invention includes: receiving first contents registration information and second contents registration information for providing an advertisement from an advertisement provider and storing the received information, the first contents registration information including basic advertisement contents and the second contents registration information including additional advertisement contents that corresponds to the basic advertisement contents; providing a stored web page and the basic advertisement contents to the user terminal; and providing the additional advertisement contents to the user terminal when receiving a user action on the basic advertisement contents for activating the additional advertisement contents from the user terminal.

After collecting the user action, the advertisement providing method includes: generating action information for the collected user action, the action information including the number of exposures/clicks of the basic advertisement contents and the number of exposures/clicks of the additional advertisement contents; and performing a billing process for respective advertisement providers of the basic advertisement contents and the additional advertisement contents based on the action information.

An exemplary system that provides an advertisement to a user terminal according to another embodiment of the present invention includes: an advertisement providing device that stores a plurality of basic advertisement contents including first basic advertisement contents and second basic advertisement contents and a plurality of first additional advertisement contents corresponding to the first basic advertisement contents, wherein at least one of the plurality of first additional advertisement contents is applied with eternity for providing a series of the first additional advertisement contents and the rest of the plurality of first additional advertisement contents are not applied with the eternity; a first contents providing device that receives the plurality of basic advertisement contents and the plurality of first additional advertisement contents from the advertisement providing device, provides a stored first web page and the first basic advertisement contents to the user terminal, and provides the plurality of first additional advertisement contents to the user terminal in response to a user action on the first basic advertisement contents provided by the user terminal; and a second contents providing device that receives the plurality of basic advertisement contents and the plurality of first additional advertisement contents from the advertisement providing device, provides a stored second web page and the second basic advertisement contents to the user terminal when the user terminal accesses from the first contents providing device, and provides the first additional advertisement contents to which eternity is applied to the user terminal in response to a user action on the second basic advertisement contents, provided from the user terminal.

The first contents providing device collects first action information on the user action received from the user terminal and provides the collected first action information to the advertisement providing device, the first action information including the number of exposures/clicks of the first basic advertisement contents and the number of exposures/clicks of the first additional advertisement contents, and the second contents providing device collects second action information for the user action received from the user terminal and provides the collected second action information to the advertisement providing device, the second action information including the number of exposures/clicks of the second basic advertisement contents and the number of exposures/clicks of the first additional advertisement contents.

An exemplary advertisement providing method of a system that provides an advertisement to a user terminal according to another embodiment of the present invention includes: receiving information on a plurality of first additional advertisement contents provided to the user terminal by a first contents providing device that provides contents, from the first contents providing device, wherein at least one of the plurality of first additional advertisement contents is applied with eternity for providing a series of first additional advertisement contents and the rest are not applied with the eternity; providing basic advertisement contents to the user terminal based on a plurality of stored first contents registration information that include the basic advertisement contents; and providing the first additional advertisement contents to which the eternity is applied among the plurality of first additional advertisement contents when a user action for the basic advertisement contents provided from the user terminal is received.

After the providing of the basic advertisement contents to the user terminal, the advertisement providing method further includes: collecting action information on the user action, the action information including the number of exposures/clicks of the basic advertisement contents and the number of exposures/clicks of the first additional advertisement contents; and transmitting the collected action information to a device that performs a billing process for billing the advertisement providers of the basic advertisement contents and the first additional advertisement contents when the user terminal terminates access.

An exemplary advertisement providing method of a system that provides an advertisement to a user terminal according to another embodiment of the present invention includes: receiving information on a plurality of first advertisement contents provided to the user terminal by a first contents providing device that provides contents from the first contents providing device, wherein at least one of the plurality of first advertisement contents is applied with eternity for providing a series of the first advertisement contents and the rest are not applied with the eternity; providing a web page in which first contents is included to the user terminal based on a plurality of stored first contents registration information, the first contents registration information including first contents that includes at least one of a word, an image, and a motion picture provided on the web page; providing first advertisement contents to which eternity is applied among the plurality of first advertisement contents to the user terminal when a user action for the first contents is received from the user terminal; collecting action information on the user action, the user action information including the number of exposures/clicks of the first advertisement contents; and transmitting the collected action information to a device that performs a billing process for billing an advertisement provider of the first advertisement contents when the user terminal terminates access.

### ADVANTAGEOUS EFFECTS

According to the present invention, maximum advertising efficiency can be expected with minimal expenses by re-selling basic advertisement contents rather than providing location-based basic advertisements.

In addition, more various advertisement contents can be provided in order to continuously attract users and enable a user to promptly acquire desired information.

In addition, various advertisement contents can be provided in series to the user with respect to web page movement of the user.

### BRIEF DESCRIPTION OF THE DRAWINGS

FIG. 1 is a block diagram of an advertisement providing system according to an exemplary embodiment of the present invention.

FIG. 2 is a detailed block diagram of an AOD device of the advertisement providing system according to the exemplary embodiment of the present invention.

FIG. 3 is a detailed block diagram of a content providing device of the advertisement providing system according to the exemplary embodiment of the present invention.

FIG. 4 and FIG. 5 are data flowcharts showing a first advertisement providing method of the advertisement providing system according to the exemplary embodiment of the present invention.

FIG. 6 to FIG. 8 are data flowcharts showing a second advertisement providing method of the advertisement providing system according to the exemplary embodiment of the present invention.

FIG. 9 is a flowchart of a pre-authorization information registering method of the AOD device of the advertisement providing system according to the exemplary embodiment of the present invention.

FIG. 10 is a detailed flowchart of a content registration method for advertisement in the AOD device of the advertisement providing system according to the exemplary embodiment of the present invention.

FIG. 11 is a flowchart of a pre-authorization process of a first content providing device according to the exemplary embodiment of the present invention.

FIG. 12 is a flowchart of a billing process of the AOD device of the advertisement providing system according to the exemplary embodiment of the present invention.

FIG. 13 is a table that the advertisement providing system according to the exemplary embodiment of the present invention displays AOD contents registration information stored in the AOD device.

FIG. 14 shows application location image confirmation among the AOD contents registration information according to the exemplary embodiment of the present invention.

### BEST MODE

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, unless explicitly described to the contrary, the word “comprise” and variations such as “comprises” or “comprising”, will be understood to imply the inclusion of stated elements but not the exclusion of any other elements. In addition, the terms “-er”, “-or” and “module” described in the specification mean units for processing at least one function and operation and can be implemented by hardware components or software components and combinations thereof.

Definitions of terms used in the specification are as follows.

Basic advertisement contents imply location-based advertisement contents in a web page, and are provided to a user through a web page of a contents providing device based on basic advertisement contents registration information stored by a sponsor (hereinafter also referred to as an advertisement provider). Here, the basic advertisement contents include advertisement contents such as images, linked words, and video information (i.e., media).

The basic advertisement contents registration information is information that is received from a sponsor and stored for providing basic advertisement contents on a web page, and includes basic advertisement contents, a type of a product to be advertised, an advertising type, advertisement providing location information, an advertisement providing site name, a running period, and sponsor information.

Advertisement on digital (AOD) contents (hereinafter also referred to as additional advertisement contents) are second advertisement contents that match basic advertisement contents or digital contents in the web page and are provided in a pop-up format, and includes images, words, or media.

The AOD contents registration information is information that is received from a sponsor and stored for providing AOD contents, and includes AOD contents, an advertising type, basic advertisement or digital content information (i.e., advertisement application information) to which the AOD contents are to be provided, AOD contents running time information, sponsor information, a product category, and a product name. In this case, the AOD contents registration information may further include eternity information that indicates information on whether to provide a series of the same AOD contents.

Action information (hereinafter also referred to as user action information) includes an accessed web page name, an advertisement number, basic advertisement contents expose/click information, AOD contents expose/click information, an access uniform resource locator (URL) address, an access time, a page movement URL address, action generation time, and action termination time.

An advertisement providing system and a method thereof according to the exemplary embodiment of the present invention will now be described in further detail with reference to the drawings.

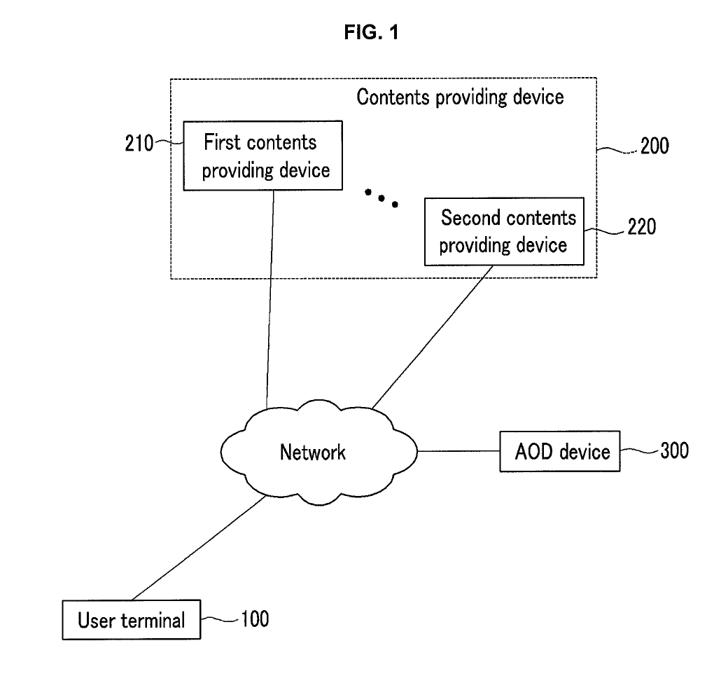

FIG. 1 is a block diagram of an advertisement providing system according to an exemplary embodiment of the present invention.

As shown in FIG. 1, the advertisement providing system according to the exemplary embodiment of the present invention includes a contents providing device 200 and an AOD device (hereinafter also referred to as an advertisement providing device) 300, and is connected wirelessly or by a cable to a user terminal 100 through the network to transmit/receive data.

The contents providing device 200 includes a first contents providing device 210 and a second contents providing device 220, and each of the contents providing devices 210 and 220 is connected to the AOD device 300 and the user terminal 100 through the network to transmit/receive data.

The contents providing device 200 receives and stores basic advertisement contents registration information and AOD contents registration information that are received by different sponsors from the AOD device 300, and provides an advertisement on the basis of stored registration information (i.e., the basic advertisement contents registration information and the AOD contents registration information) when the user terminal 100 accesses.

In addition, the contents providing device 200 collects user action information on a user action that is received through the user terminal 100 and provides the collected user action information to the AOD device 300.

The AOD device 300 receives and stores basic advertisement contents registration information for basic advertisement contents to be provided on a web page of the contents providing device 200 from a sponsor, and receives and stores AOD contents registration information for AOD contents matching the basic advertisement contents and to be provided to the user terminal 100 from the sponsor. In addition, the AOD device 300 provides the stored basic advertisement contents registration information and AOD contents registration information to the contents providing device 200.

Further, the AOD device 300 receives user action information on the user action from the contents providing device 200, and generates statistical information and billing information based on the received user action information. In addition, the AOD device 300 performs a billing process for each sponsor based on the generated billing information.

The user terminal 100 includes a terminal (e.g., a personal computer or a radio access terminal) that can transmit/receive data through the network, provides a web page, basic advertisement contents, and AOD contents received by accessing the contents providing device 200 to the user, and transmits a user action to the contents providing device 200.

Although the contents providing device and the AOD device are separately configured and connected to each other through the network according to the exemplary embodiment of the present invention, they can be realized in one integrated device.

Since the advertisement providing system provides an advertisement (in a pop-up form on basic advertisement contents) on basic advertisement contents that has already been provided to the user, the advertisement providing system has a merit in that the user can be provided with various advertisements without moving to other web pages. In addition, the advertisement providing system provides AOD contents which is the second advertisement to the user so that it has another merit in that a sponsor can maximize advertising efficiency with minimal expenses by re-selling basic advertisement contents.

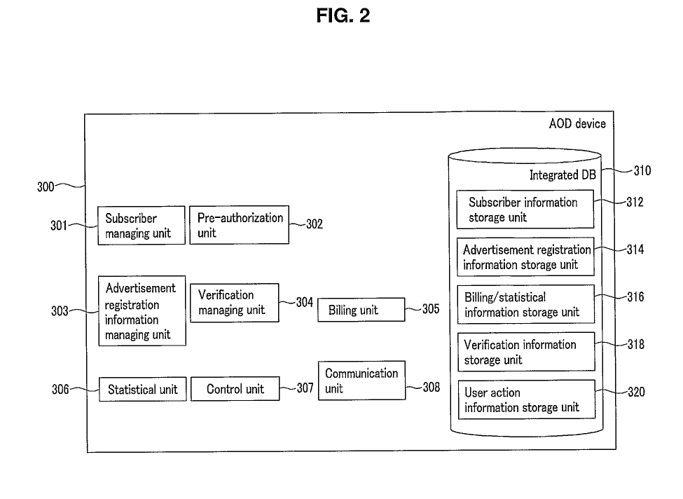

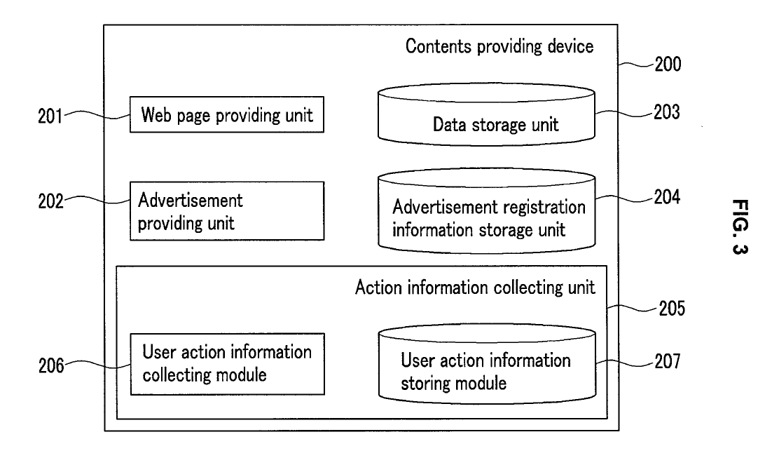

Referring to FIG. 2 and FIG. 3, the AOD device and the contents providing device of the advertisement providing system will be described in further detail.

FIG. 2 is a detailed block diagram of the AOD device of the advertisement providing system according to the exemplary embodiment of the present invention.

As shown in FIG. 2, the AOD device 300 according to the exemplary embodiment of the present invention includes a subscriber managing unit 301, a pre-authorization unit 302, an advertisement registration information managing unit 303, a verification managing unit 304, a billing unit 305, a statistical unit 306, a control unit 307, a communication unit 308, and an integrated database (DB) 310.

The subscriber managing unit 301 performs an authorization management function for each sponsor. The subscriber managing unit 301 stores authorization information provided during a subscription process in a subscriber information storage unit 312 of the integrated DB 310, and, when a sponsor accesses, the subscriber managing unit 301 authorizes the accessed sponsor based on the stored authorization information.

The pre-authorization unit 302 manages pre-authorization application information on whether the contents providing device 200 is to apply AOD contents. In further detail, the pre-authorization unit 302 inquires whether pre-authorization is applied for AOD contents application to a contents providing device 200 to which AOD contents are to be displayed and stores a response of the inquiry.

The advertisement registration information managing unit 303 performs a purchasing process function for registration of advertisement contents (i.e., basic advertisement contents and AOD contents). Here, the advertisement registration information managing unit 303 receives basic advertisement contents registration information on basic advertisement contents to be displayed as an advertisement from a sponsor, and stores and manages the received advertisement registration information in an advertisement registration information storage unit 314 of the integration DB 310.

The verification managing unit 304 performs a function for determining appropriateness of advertisement contents (i.e., basic advertisement contents and AOD contents) received from a sponsor. In further detail, the verification managing unit 304 stores verification information on words, text, and images that cannot be used in an verification information storage unit 318 of the integrated DB 310 in advance, and filters advertisement contents on the basis of the stored verification information when advertisement contents are received from a sponsor.

The billing unit 305 generates billing information for each sponsor based on statistical information and stores the billing information in a billing/statistical information storage unit 316, and performs a billing process for a sponsor based on stored billing information for each sponsor. In this case, the billing unit 305 generates billing information respectively for basic advertisement contents and AOD contents for each sponsor based on expose/click information of each of the number of exposures/clicks of basic advertisement contents and the number of exposures/clicks of AOD contents, a running period, a product type, and a sponsor type that are calculated by collected action information (e.g., expose/click information on basic advertisement contents, expose/click information on AOD contents, etc.).

The statistical unit 306 generates statistical information for each sponsor based on action information on a user action stored in a user action information storage unit 320 of the integrated DB 310 and stores the generated statistical information in the billing/statistical information storage unit 316. In further detail, the statistical unit 306 generates information on the number of exposures/clicks of the basic advertisement contents and information on the number of exposures/clicks of the AOD contents respectively based on the basic advertisement contents expose/click information and the AOD contents expose/click information included in the action information and calculates the number of exposures/clicks of basic advertisement contents and the number of exposures/clicks of AOD contents for each sponsor based on the generated information. In this case, the statistical unit 306 performs statistics on eternity confirmation based on stored AOD contents registration information for AOD contents.

The communication unit 308 transmits/receives data to/from the contents providing device 200 through the network.

The integrated DB 310 includes the subscriber information storage unit 312, the advertisement registration information storage unit 314, the billing/statistical information storage unit 316, the verification information storage unit 318, and the user action information storage unit 320, and stores subscriber information, advertisement registration information, billing/statistical information, verification information, and action information.

The control unit 307 manages the subscriber managing unit 301, the pre-authorization unit 302, the advertisement registration information managing unit 303, the verification managing unit 304, the billing unit 305, the statistical unit 306, the communication unit 308, and the integrated DB 310, and controls data processing between the respective units 301, 302, 303, 304, 305, 306, 307, 308, and 310.

In addition, the control unit 307 provides advertisement registration information (i.e., basic advertisement contents registration information and AOD contents registration information) stored in the advertisement registration information storage unit 314 of the integrated DB 310 to the contents providing device 200 through the communication unit 308, and receives action information from the contents providing device 200 and stores the received action information in the user action information storage unit 320 of the integrated DB 310.

FIG. 3 is a detailed block diagram of the contents providing device of the advertisement providing system according to the exemplary embodiment of the present invention.

As shown in FIG. 3, the contents providing device 200 according to the exemplary embodiment of the present invention includes a web page providing unit 201, an advertisement providing unit 202, a data storage unit 203, an advertisement registration information storage unit 204, and an action information collecting unit 205.

The web page providing unit 201 is connected to the user terminal 100 through the network to transmit/receive data, and when the user terminal 100 accesses, the web page providing unit 201 provides a web page stored in the data storage unit 203 to the user terminal 100 and receives a user action (e.g., mouse-over action or click action) from the user terminal 100. Here, the mouse-over action indicates an action in which the user moves the mouse pointer over an object without clicking the object. For example, the mouse-over action includes an action in which the user moves the mouse pointer over the basic advertisement contents.

In addition, the web page providing unit 201 provides a web page with a plurality of basic advertisement contents included therein to the user terminal 100, and when receiving a user action (e.g., mouse-over for basic advertisement contents, etc.) for activating AOD contents from the user terminal 100, the web page providing unit 201 receives AOD contents corresponding to the corresponding basic advertisement contents from the advertisement providing unit 202 and provides the received AOD contents to the user terminal 100.

The advertisement providing unit 202 interacts with the web page providing unit 201, and when the web page providing unit 201 provides a web page to the user terminal 100, the advertisement providing unit 202 provides basic advertisement contents based on the basic advertisement contents registration information stored in the advertisement registration information storage unit 204, and when receiving the user action (e.g., mouse-over for basic advertisement contents) for activating AOD contents, the advertisement providing unit 202 provides AOD contents that correspond to the basic advertisement contents based on the advertisement registration information.

In this case, when receiving the user action for activating the AOD contents, the advertisement providing unit 202 activates or deactivates the AOD contents based on pre-authorization information included in AOD contents registration information. Here, when the AOD contents are activated, the AOD contents are provided to the user terminal, and when the AOD contents are deactivated, the AOD contents are not provided to the user terminal.

In addition, in the case of receiving AOD contents providing information from a different contents providing device, the advertisement providing unit 202 selects AOD contents to which the eternity is applied among AOD contents provided by the different contents providing device based on the AOD contents providing information when receiving a user action (e.g., mouse-over, etc.) on basic advertisement contents for activating AOD contents, and provides the selected AOD contents to the user terminal.

The advertisement registration information storage unit 204 receives and stores basic advertisement contents registration information and AOD contents registration information received from the AOD device 300.

The action information collecting unit 205 includes a user action information collecting module 206 and a user action information storing module 207.

The user action information collecting module 206 collects action information that is received corresponding to advertisement contents (basic advertisement contents and AOD contents included) provided to the user. In this case, the user action information collecting module 206 terminates action information collection and transmits collected action information to the AOD device 300 when the user terminal 100 moves to a web page that matches the basic advertisement contents and the AOD contents.

In addition, when receiving a message that informs access to a web page corresponding to the AOD contents from the user terminal 100, the user action information collecting module 206 generates AOD contents providing information for AOD contents provided to the user terminal 100 and transmits the AOD contents providing information to a contents providing device that provides a web page of the corresponding AOD contents.

The user action information storing module 207 temporarily stores action information collected by the user action information collecting module 206.

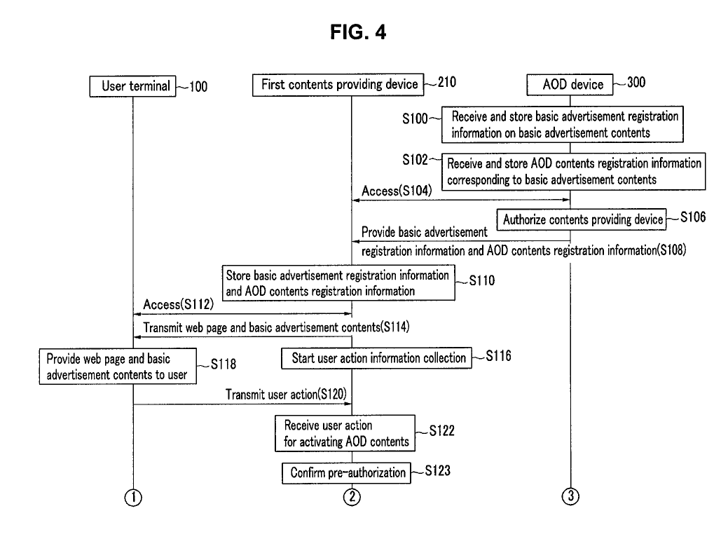

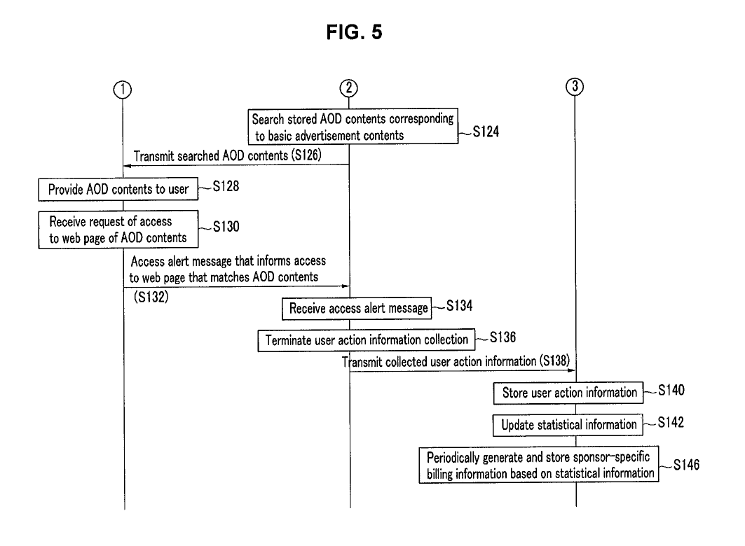

FIG. 4 and FIG. 5 are flowcharts of a first advertisement providing method of the advertisement providing system according to the exemplary embodiment of the present invention.

As shown in FIG. 4 and FIG. 5, the advertisement providing method according to the exemplary embodiment of the present invention is performed when the AOD device 300 receives basic advertisement contents registration information for location-based basic advertisement contents from a sponsor.

The AOD device 300 receives basic advertisement contents registration information for location-based basic advertisement contents from a sponsor, and stores the received basic advertisement contents registration information (S100).

In addition, the AOD device 300 receives AOD contents registration information for AOD contents that corresponds to basic advertisement contents from the sponsor, and stores the received AOD contents registration information (S102).

When the first contents providing device 210 accesses (S104), the AOD device 300 performs contents providing device authorization for the first contents providing device 210 (S106). In this case, the AOD device 300 authorizes the first contents providing device 210 based on stored authorization information.

When the authorization has succeeded, the AOD device 300 transmits stored basic advertisement contents registration information and AOD contents advertisement registration information to the first contents providing device 210 (S108).

The first contents providing device 210 receives the basic advertisement contents registration information and the AOD contents advertisement registration information from the AOD device 300 and stores the received information (S110).

When the user terminal 100 accesses (S112), the first contents providing device 210 transmits a stored web page and basic advertisement contents to the user terminal 100 (S114).

Then, the first contents providing device 210 starts to collect action information for a user action received from the user terminal 100 (S116).

The user terminal 100 provides the received web page and basic advertisement contents to the user (S118), and receives a user action (e.g., mouse pointer movement, etc.) from the user and transmits the received user action to the first contents providing device 210 (S120).

The first contents providing device 210 receives the user action (e.g., mouse pointer movement, etc.) in real-time, and, when receiving the user action (e.g., mouse over to basic advertisement contents) to activate AOD contents for basic advertisement contents on the web page (S122), the first contents providing device 210 performs pre-authorization confirmation (S123).

In further detail, when receiving the user action (e.g., mouse-over for the basic advertisement contents, etc.) for activating the AOD contents for the basic advertisement contents from the user terminal 100, the first contents providing device 210 determines whether it is pre-authorized to provide the AOD contents for the basic advertisement contents and provides the AOD contents according to the determination. In this case, the first contents providing device 210 determines the pre-authorization status based on pre-authorization information included in the AOD contents registration information.

The first contents providing device 210 searches stored AOD contents corresponding to first advertisement contents (S124), and transmits the searched AOD contents to the user terminal 100 for displaying the searched AOD contents over the basic advertisement contents (S126).

The user terminal 100 provides the AOD contents received from the first contents providing device 210 to the user by displaying the AOD contents over the basic advertisement contents (S128). In this case, the user terminal 100 may separately provide the AOD contents in a pop-up form.

When receiving a request to access a web page that matches the AOD contents from the user corresponding to the providing of the AOD contents (i.e., when moving to the corresponding web page by clicking the AOD contents) (S130), the user terminal 100 moves to a contents providing device that matches a web page of the corresponding AOD contents. Simultaneously, the user terminal 100 generates an access alert message to inform access to the web page that matches the AOD contents and transmits the access alert message to the first contents providing device 210 (S132).

If the web page that matches the AOD contents received from the user corresponding to the providing of the AOD contents is a web page provided by the first contents providing device 210, the first contents providing device 210 may accumulate action information until there is movement to another contents providing device.

The first contents providing device 210 receives the access alert message from the user terminal 100 (S134), and terminates the collection of the user action (S136).

In addition, the first contents providing device 210 transmits the collected action information to the AOD device 300 (S138).

The AOD device 300 receives the action information from the first contents providing device 210 and stores the received action information (S140), and updates the statistical information based on the action information (S142).

The AOD device 300 periodically (e.g., every week, every month, or every year) generates and stores billing information for each sponsor based on statistical information (S146), and performs a billing process for a sponsor based on the stored billing information.

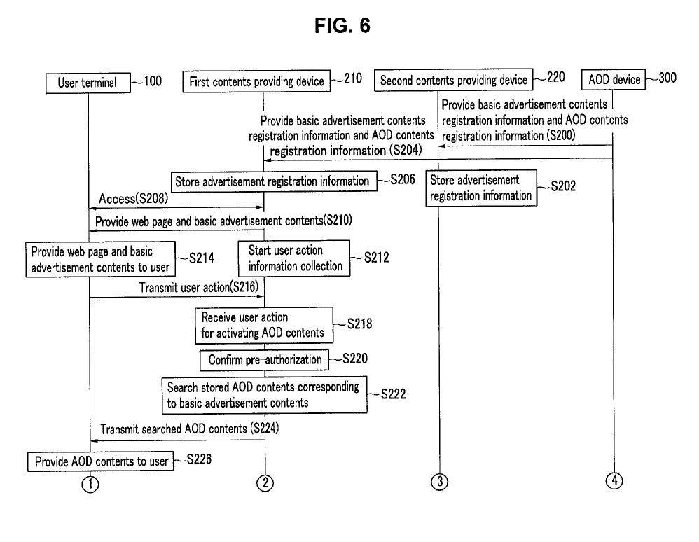

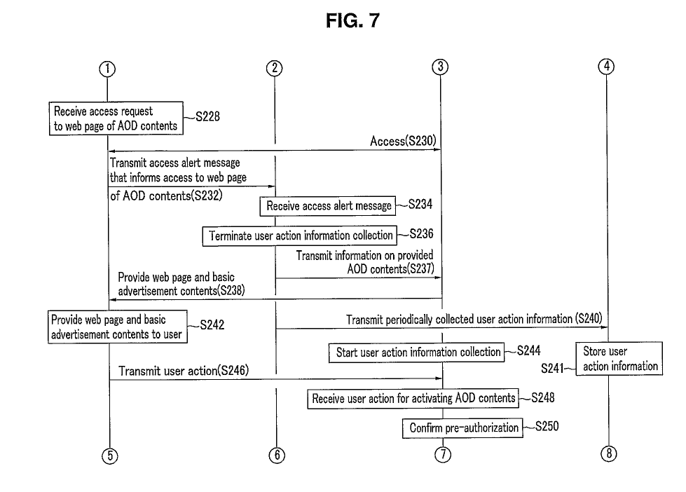

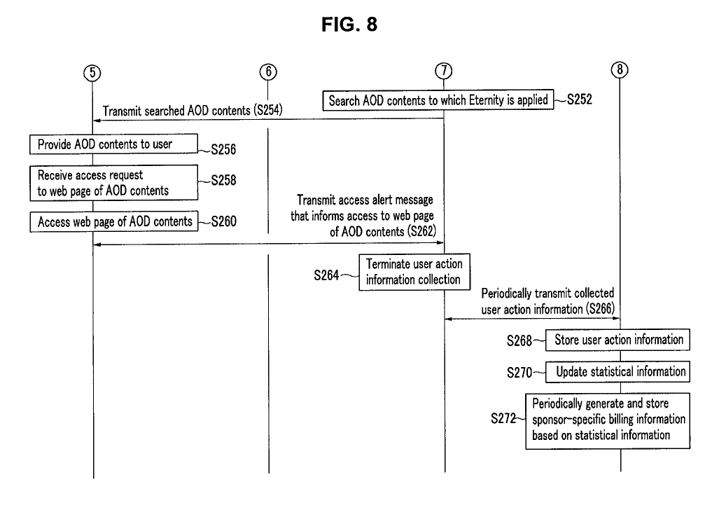

FIG. 6 to FIG. 8 show data flowcharts of a second advertisement providing method of the advertisement providing system according to the exemplary embodiment of the present invention.

As shown in FIG. 6 to FIG. 8, the second advertisement providing method according to the exemplary embodiment of the present invention is performed when the AOD device 300 provides basic advertisement contents registration information and AOD contents registration information to the first and second contents providing devices 210 and 220.

When the first and second contents providing devices 210 and 220 access, the AOD device 300 provides stored basic advertisement contents registration information and AOD contents registration information received from sponsors to the first contents providing device 210 and the second contents providing device 220 (S200 and S204).

In this case, the AOD device 300 provides a plurality of basic advertisement contents registration information and a plurality of AOD contents registration information that respectively correspond to the plurality of basic advertisement contents registration information to the first contents providing device 210 and the second contents providing device 220.

Hereinafter, for better understanding of the present invention, it is assumed that the AOD device 300 provides one basic advertisement contents registration information and a plurality of AOD contents registration information corresponding to the one basic advertisement contents registration information.

The first contents providing device 210 and the second contents providing device 220 store the received basic advertisement contents registration information and the plurality of AOD contents registration information (S202 and S206).

When the user terminal 100 accesses (S208), the first contents providing device 210 transmits a stored web-page and basic advertisement contents to the user terminal 100 (S210).

Then, the first contents providing device 210 starts to collect action information for a user action received from the user terminal 100 (S212).

The user terminal 100 provides the received web page and basic advertisement contents to the user (S214), and transmits a user action (e.g., mouse pointer movement, etc.) received from the user to the first contents providing device (S216).

The first contents providing device 210 receives the user action (e.g., mouse pointer movement, etc.) in real-time, and, when receiving the user action (e.g., mouse-over to basic advertisement contents) to activate AOD contents for basic advertisement contents on the web page (S218), the first contents providing device 210 performs pre-authorization confirmation (S220). When the pre-authorization is confirmed, the first contents providing device 210 searches stored AOD contents corresponding to the basic advertisement contents (S222), and transmits the searched AOD contents to the user terminal 100 (S224). In this case, the first contents providing device 210 provides the searched AOD contents to the user terminal 100 by displaying the searched AOD contents on the same web page as the basic advertisement contents. For example, the searched AOD contents are separately provided in a pop-up form.

The user terminal 100 provides the plurality of AOD contents received from the first contents providing device 210 to the user by displaying the plurality of AOD contents over the basic advertisement contents (S226).

The user terminal 100 receives a request to access a web page of a second contents providing device 220, matching one of AOD contents selected from among the plurality of AOD contents from the user (S228), and accesses the web page of the second contents providing device 220 (S230). Simultaneously, the user terminal 100 generates an access alert message to inform the access to the second contents providing device 220 and transmits the access alert message to the first contents providing device 210 (S232).

The first contents providing device 210 receives the access alert message from the user terminal 100 (S234), and terminates action information collection for the user action (S236). In addition, the first contents providing device 210 generates information on AOD contents provided to the user terminal 100, and provides the information to the second contents providing device (S237).

The first contents providing device 210 transmits collected action information to the AOD device 300 (S240).

The AOD device 300 stores the action information received from the first contents providing device 210 (S241).

The second contents providing device 220 provides a stored web page and basic advertisement contents to the user terminal 100 accessed through the AOD contents (S238). Then, the second contents providing device 220 starts to collect action information on the user action received from the user terminal 100 (S244).

The user terminal 100 provides the received web page and basic advertisement contents to the user (S242), and transmits the user action (e.g., mouse pointer movement, etc.) received from the user to the second contents providing device 220 (S246).

The second contents providing device 220 receives a user action in real-time, and, when receiving a user action (e.g., mouse-over for basic advertisement contents) for activating AOD contents for basic advertisement contents on the web page (S248), the second contents providing device 220 performs pre-authorization confirmation (S250). In addition, when the pre-authorization is confirmed, the second contents providing device 220 searches AOD contents to which the eternity is applied among the AOD contents provided by the first contents providing device 210 based on the AOD contents information received from the first contents providing device 210 (S252).

Then, the second contents providing device 220 provides the searched AOD contents to the user terminal 100 (S254). In this case, the second contents providing device 200 provides a plurality of searched AOD contents to the user terminal 100 by displaying the plurality of searched AOD contents over the basic advertisement contents. That is, the second contents providing device 200 provides the AOD contents to the user terminal 100 by displaying the AOD contents on the same web page as the basic advertisement contents. For example, the AOD contents are provided in a separate pop-up form.

The user terminal 100 receives AOD contents from the second contents providing device 220, and provides a plurality of received AOD contents to the user by displaying the plurality of received AOD contents over the basic advertisement contents (S256).

The user terminal 100 receives a request to access a web page of a third contents providing device (not shown), matching one of AOD contents selected from among the plurality of AOD contents from the user (S258) corresponding to the providing of the plurality of AOD contents, and accesses the web page of the third contents providing device (not shown) (S260). Simultaneously, the user terminal 100 generates an access alert message to inform the access to the third contents providing device and transmits the access alert message to the second contents providing device 220 (S262).

The second contents providing device 220 receives the access alert message from the user terminal 100, and terminates action information collection for the user action (S264). In addition, the second contents providing device 220 generates information on AOD contents provided to the user terminal 100, and provides the generated information to the third contents providing device.

The second contents providing device 220 periodically transmits collected action information to the AOD device 300 (S266).

The AOD device 300 stores the action information received from the second contents providing device 220 (S268).

The AOD device 300 updates statistical information on the use of advertisement of the user based on the action information received from the first contents providing device 210 and the second contents providing device 220 (S270). In addition, the AOD device 300 periodically generates billing information for each sponsor based on the statistical information and performs a billing process for a sponsor (S272).

Here, the first contents providing device 210 and the second contents providing device 220 may be realized in one integrated device and respectively provide different web pages, or may be independent devices.

As shown in FIG. 6 to FIG. 8, eternal AOD contents are provided by using the basic advertisement contents according to the exemplary embodiment of the present invention, and an advertisement not for advertisement contents but for digital contents may be eternally provided in the same manner as the advertisement providing method by using the basic advertisement contents. In this case, the digital contents include keywords, images, and motion pictures provided on a web page.

When providing an advertisement by using a user action for the digital contents, the first contents providing device 210 and the second contents providing device 220 respectively collect user actions only for AOD contents, and AOD device 300 performs a billing process for an advertisement provider of the AOD contents only.

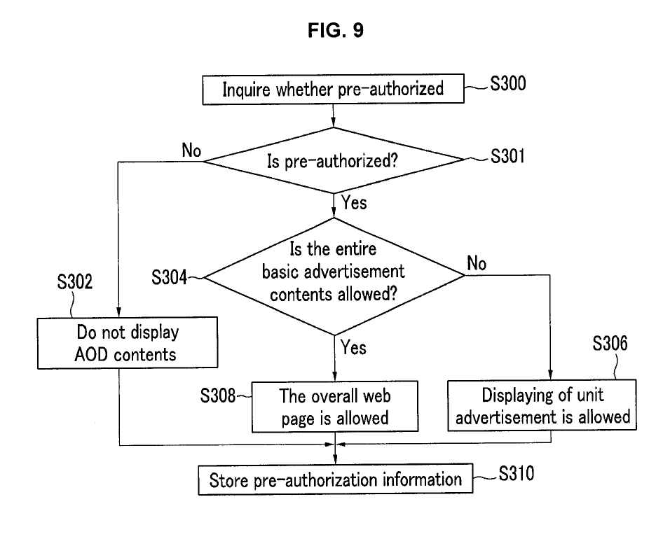

FIG. 9 is a flowchart of a pre-authorization information registration method of the AOD device of the advertisement providing system according to the exemplary embodiment of the present invention.

As shown in FIG. 9, a pre-authorization information registration method according to the exemplary embodiment of the present invention is performed when the contents providing device 200 accesses the AOD device 300.

When the contents providing device 200 accesses, the pre-authorization unit 302 of the AOD device 300 requests to confirm whether displaying of basic advertisement contents on a web page is pre-authorized and whether the entire basic advertisement contents are allowed in the overall web pages of the contents providing device 200.

The AOD device 300 receives responses to the request for the confirmation on the pre-authorization status and the entire allowance status from the contents providing device 200, and determines whether the response is about allowance of the pre-authorization on the basic advertisement contents (S301).

When the contents providing device 200 does not allow the pre-authorization according to the determination result of the step of S300, the AOD device 300 determines that the contents providing device 200 does not allow the basic advertisement to be advertised and stores the pre-authorization information (S302 and S310).

When the contents providing device 200 allows the pre-authorization according to the determination result of the step of S300, the AOD device 300 determines whether the entire allowance is pre-authorized (S304).

When the entire allowance is pre-authorized according to the determination result of the step of S304, the AOD device 300 determines that advertising of the basic advertisement contents is allowed in the overall web pages of the contents providing device 200 and stores the pre-authorization information (S308 and S310).

When the entire allowance is not pre-authorized according to the determination result of the step of S304, the AOD device 300 determines that the advertising of the basic advertisement contents in a part of the web pages is allowed, and stores information on an allowed web page included in the response by including the information in the pre-authorization information (S306 and S310).

The advertisement providing system according to the exemplary embodiment of the present invention checks and stores pre-authorization information for providing AOD contents for basic advertisement contents in advance from the contents providing device so that problems related to copyright or advertising can be prevented in advance.

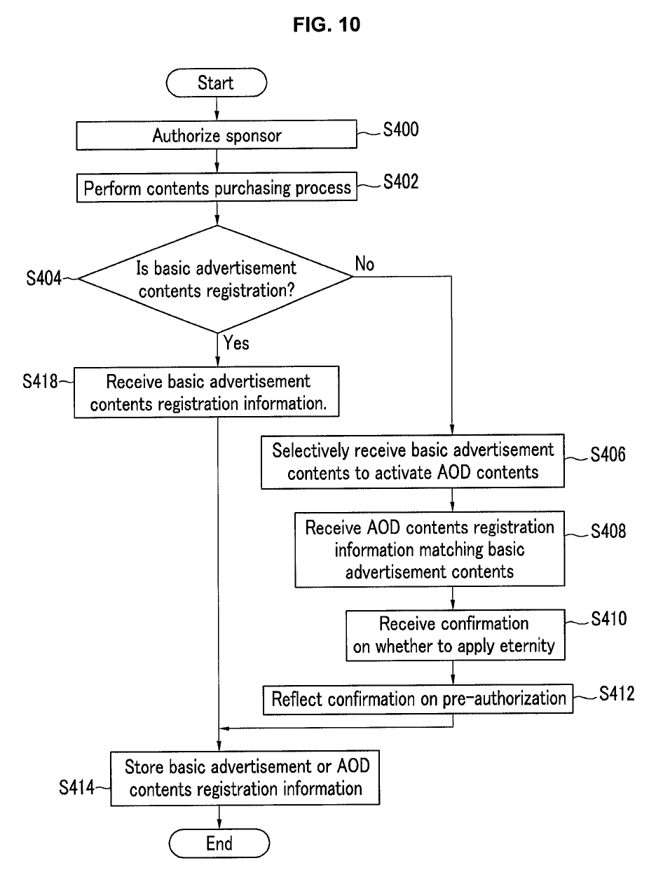

FIG. 10 is a detailed flowchart of a contents registration method for advertisement in the AOD device of the advertisement providing system according to the exemplary embodiment of the present invention.

As shown in FIG. 10, the AOD device 300 according to the exemplary embodiment of the present invention authorizes a sponsor when the sponsor accesses through a terminal of the sponsor (S300). In further detail, the AOD device 300 has stored authorization information of the sponsor, registered during a subscription process of the sponsor, and the AOD device 300 authorizes the sponsor through comparison with the stored authorization information when receiving sponsor information from the sponsor for authorization.

After authorizing the sponsor (S400), the AOD device 300 performs a contents purchasing process (S402). The contents purchasing process refers to a process for a sponsor to purchase basic advertisement contents or AOD contents.

The AOD device 300 inquires whether registration is for basic advertisement contents or for AOD contents, and accordingly receives selection information that indicates whether or not the registration is for the basic advertisement contents from a sponsor to determine whether the registration is for the basic advertisement contents (S404).

When the selection information received from the sponsor in the step of S404 corresponds to the basic advertisement contents registration, the AOD device 300 receives basic advertisement contents registration information from the sponsor and stores the received information (S418).

When the selection information received from the sponsor in the step of S304 corresponds not to the basic advertisement contents but to the AOD contents, the AOD device 300 provides information on basic advertisement contents that will activate the AOD contents to the user, and accordingly receives selection of basic advertisement contents that will activate the AOD contents from the sponsor (S406).

Then, the AOD device 300 receives AOD contents registration information that corresponds to the basic advertisement contents received from the sponsor from the user (S408). In addition, the AOD device 300 receives determination on whether to apply eternity to the AOD contents from the sponsor (S410).

Then, the AOD device 300 reflects confirmation on whether a contents providing device 200 of an advertisement providing site to which basic advertisement contents are to be displayed is pre-authorized to provide AOD contents based on stored pre-authorization information (S412).

The AOD device 300 includes a result of confirmation on whether to reflect the pre-authorization status and whether to apply eternity in AOD contents registration information and stores the AOD contents registration information (S414).

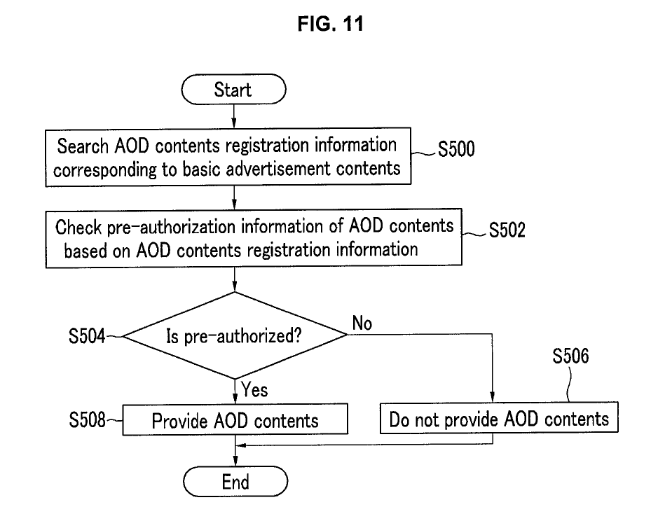

FIG. 11 is a flowchart of a pre-authorization process of the first contents providing device according to the exemplary embodiment of the present invention.

As shown in FIG. 11, the first contents providing device 210 according to the present embodiment searches AOD contents registration information that corresponds to basic advertisement contents (S500), and checks confirmation on pre-authorization status included in the searched AOD contents registration information (S502). In addition, the first contents providing device 210 determines whether the first contents providing device 210 is pre-authorized to disclose AOD contents based on the pre-authorization confirmation information (S504).

When the first contents providing device 210 is pre-authorized according to a result of the determination of the step of S504, the first contents providing device 210 provides AOD contents matching the basic advertisement contents to the user terminal 100 (S506).

When the first contents providing device 210 did not pre-authorize according to the result of the determination of the step of S504, the searched AOD contents are not provided (S508).

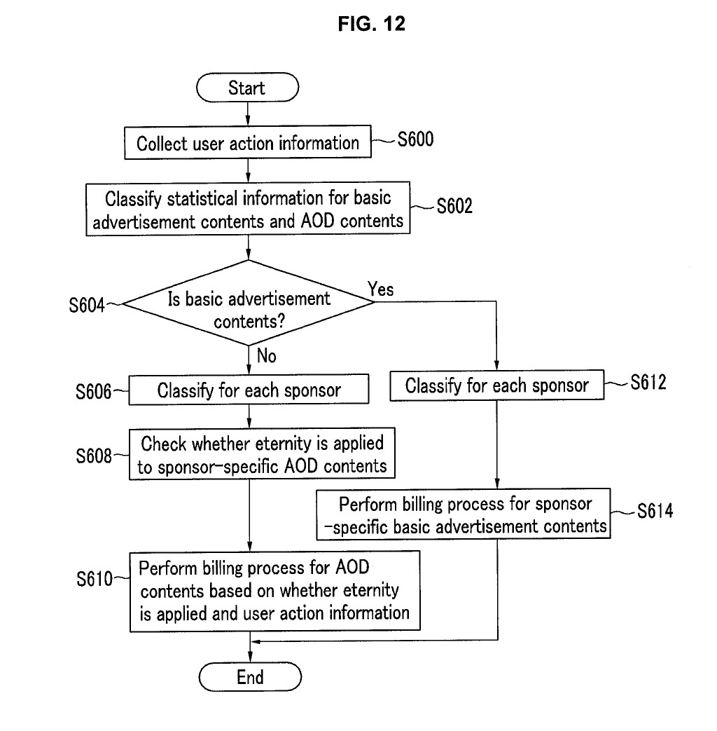

FIG. 12 is a flowchart of a billing process of the AOD device of the advertisement providing device according to the exemplary embodiment of the present invention.

As shown in FIG. 12, a billing process according to the exemplary embodiment of the present invention is performed when the AOD device 300 collects action information from the respective contents providing devices 210 and 220.

Here, the billing process may be periodically (e.g., every week, every month, or every year) performed, and may be performed by a request of a sponsor.

First, the AOD device 300 collects action information from each of the contents providing devices 210 and 220 (S600), and generates statistical information for each sponsor based on the collected action information.

The AOD device 300 classifies statistical data for each of basic advertisement contents and AOD contents based on stored statistical information (S602).

The AOD device 300 determines whether the classified statistical data corresponds to basic advertisement contents (S604), and re-classifies statistical data for each sponsor if the classified statistical data does not correspond to the basic advertisement contents (i.e., if the classified statistical data corresponds to AOD contents) (S606).

In addition, the AOD device 300 checks whether eternity is applied to AOD contents that are classified for each sponsor (i.e., checks the number of AOD contents to which eternity is applied among AOD contents) S608, and performs a billing process for sponsor-specific AOD contents based on the eternity application confirmation and the number of AOD contents exposures/clicks (S610). In further detail, the AOD device 300 generates billing information for each sponsor based on the eternity application confirmation, the number of AOD contents exposures/clicks, a running period, and a product type (i.e., AOD contents) and performs the billing process.

When the classified statistical information is determined to be the basic advertisement contents according to the result of the determination of the step of S604, the AOD device 300 re-classifies the basic advertisement contents for each sponsor (S612), and then performs billing process for respective sponsors for basic advertisement contents (S614). In further detail, the AOD device 300 generates sponsor-specific billing information for billing a sponsor for basic advertisement contents based on the number of exposures/clicks of the basic advertisement contents, a running period, and a product type (i.e., basic advertisement contents).

Such an advertisement providing system according to the exemplary embodiment of the present invention has a merit in that a graded billing process can be efficiently performed for respective sponsors of basic advertisement contents and AOD contents by performing a graded billing process for each of the basic advertisement contents and the AOD contents. Particularly, since the advertisement providing system of the present exemplary embodiment can provide a plurality of AOD contents based on basic advertisement contents, more various advertisements can be provided to a user compared to a conventional advertisement providing device that provides location-based basic advertisement contents, and accordingly, advertising effects can be significantly increased.

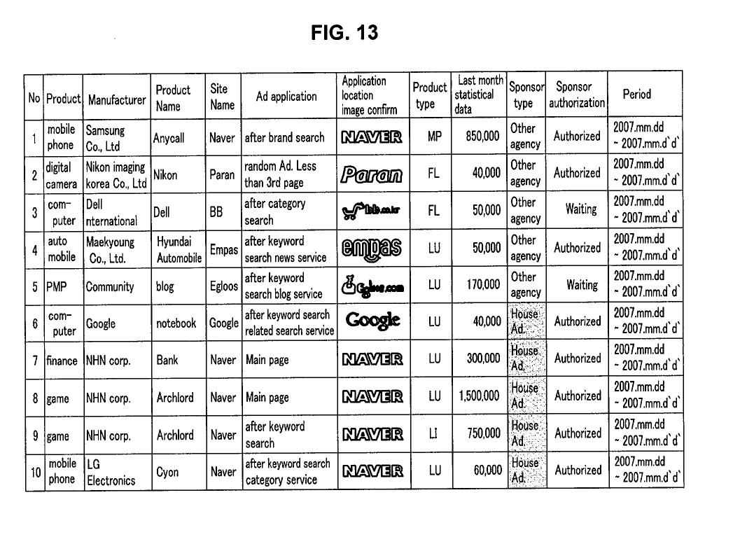

FIG. 13 is a table that the advertisement providing system according to the exemplary embodiment of the present invention displays AOD contents registration information stored in the AOD device.

As shown in FIG. 13, the AOD contents registration information according to the exemplary embodiment of the present invention includes a product category, a manufacturer, a product name, a site name, an advertisement application, an application location image confirmation, a product type, last month statistical data, sponsor authorization status, and a period.

The product category denotes a category (group) of a product, the manufacturer denotes a sponsor who owns AOD contents, the product name denotes a product name (which can be used as a search keyword) applied to AOD contents, the site name denotes a name of a site to which the AOD contents are to be applied, the advertisement application denotes a location of basic advertisement contents to which the AOD contents is applied, the application location confirmation denotes a link address of a location of basic advertisement contents to which the corresponding AOD contents are applied, and the product type denotes a product type of AOD contents, such as linked URL (LU), flash (FL), media play (MP), and linked image (LI).

In addition, the last month statistical data denotes the number of mouse-overs for basic advertisement contents and the number of clicks of AOD contents (i.e., the number of exposures/clicks of AOD contents) for activating the AOD contents. In this case, the number of mouse-overs for basic advertisement contents and the number of clicks of the basic advertisement contents are values extracted on the basis of action information transmitted from the respective contents providing devices 210 and 220 to the AOD device 300.

The sponsor authorization status denotes pre-authorization information of the contents providing device 200 to which the basic advertisement contents to be displayed. “Authorized” indicates that the corresponding contents providing devices 210 and 220 authorize providing of AOD contents matching basic advertisement contents, and “Waiting” indicates a waiting state for a pre-authorization response from the contents providing devices 210 and 220.

The period denotes a period set by a sponsor for providing AOD contents during a running period of basic advertisement contents.

Here, the AOD contents registration information may further include eternity information on whether to provide a series of the same advertisement (i.e., eternal advertisement) with web page movement.

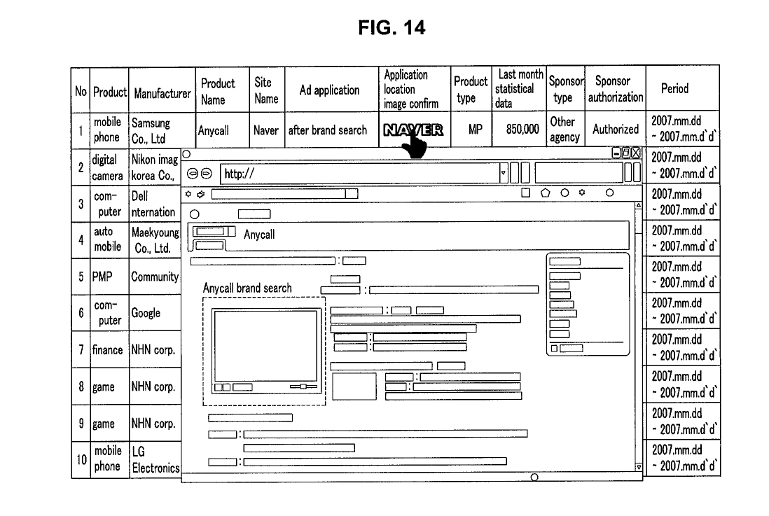

FIG. 14 shows application location image confirmation among the AOD contents registration information according to the exemplary embodiment of the present invention.

As shown in FIG. 14, the AOD device 300 according to the exemplary embodiment of the present invention provides a link address for checking a location of AOD contents to be displayed to a sponsor of the AOD contents after the AOD contents registration information is stored.

The above-described embodiments can be realized through a program for realizing functions corresponding to the configuration of the embodiments or a recording medium for recording the program in addition to through the above-described device and/or method, which is easily realized by a person skilled in the art.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1-20. (canceled)

21. An advertisement providing system that provides an advertisement to a user terminal, comprising:
a contents providing device that provides a web page and basic advertisement contents to the user terminal, provides additional advertisement contents to the user terminal in response to a user action on the basic advertisement contents for activating the additional advertisement contents, and collects action information for the user action, the action information including a number of exposures/clicks of the basic advertisement contents and a number of exposures/clicks of the additional advertisement contents; and
an advertisement providing device that provides the basic advertisement contents and the additional advertisement contents to the contents providing device and performs a billing process for respective advertisement providers of the basic advertisement contents and the additional advertisement contents.

22. The advertisement providing system of claim 21, wherein the advertisement providing device performs a billing process for an advertisement provider with grades for the basic advertisement contents based on the number of exposures/clicks of basic advertisement contents included in the action information and stored information including a running period of the basic advertisement contents and a format of the basic advertisement contents, and performs a billing process for an advertisement provider with grades for the additional advertisement contents based on the number of exposures/clicks of additional advertisement contents and stored information including a running period of the additional advertisement contents and a format of the additional advertisement contents.

23. The advertisement providing system of claim 22, wherein the contents providing device transmits the collected action information to the advertisement providing device when receiving a message that informs of access to a web page of the additional advertisement contents from the user terminal.

24. The advertisement providing system of claim 21, wherein the advertisement providing device receives a registration request for at least one of the basic advertisement contents and the additional advertisement contents from an advertisement provider, performs filtering on at least one of the registration-requested basic advertisement contents and additional advertisement contents based on stored verification information, and stores at least one of the basic advertisement contents and the additional advertisement contents.

25. The advertisement providing system of claim 21, wherein the contents providing device provides the additional advertisement contents to the user terminal for displaying the additional advertisement contents on the web page in response to a user action for the basic advertisement contents.

26. The advertisement providing system of claim 21, wherein the contents providing device provides the additional advertisement contents to the user terminal for displaying the additional advertisement contents in a pop-up form in response to a user action to the basic advertisement contents.

27. An advertisement providing method of a system that provides an advertisement to a user terminal, the advertisement providing method comprising:
receiving first contents registration information and second contents registration information for providing an advertisement from an advertisement provider and storing the received information, the first contents registration information including basic advertisement contents and the second contents registration information including additional advertisement contents that corresponds to the basic advertisement contents;
providing a stored web page and the basic advertisement contents to the user terminal; and
providing the additional advertisement contents to the user terminal when a user action is collected on the basic advertisement contents for activating the additional advertisement contents from the user terminal.

28. The advertisement providing method of claim 27, wherein, after the user action is collected, the advertisement providing method comprises:
generating action information for the collected user action, the action information including the number of exposures/clicks of the basic advertisement contents and the number of exposures/clicks of the additional advertisement contents; and
performing a billing process for respective advertisement providers of the basic advertisement contents and the additional advertisement contents based on the action information.

29. The advertisement providing method of claim 28, wherein the first contents registration information further comprises a running period of basic advertisement contents and the second contents registration information further comprises a running period of the additional advertisement contents, and the performing of the billing process comprises:
performing a billing process for the advertisement provider of the basic advertisement contents based on the running period of the basic advertisement contents and the number of exposures/clicks of the basic advertisement contents; and
performing a billing process for the advertisement provider of the additional advertisement contents based on the running period of the additional advertisement contents and the number of exposures/clicks of the additional advertisement contents.

30. The advertisement providing method of claim 27, wherein the providing of the additional advertisement contents to the user terminal comprises providing the additional advertisement contents to the user terminal for displaying the additional advertisement contents in a pop-up form when a user action for the basic advertisement contents is collected.

31. A system for providing an advertisement to a user terminal, the system comprising:
an advertisement providing device that stores a plurality of basic advertisement contents including at least first basic advertisement contents and second basic advertisement contents and a plurality of first additional advertisement contents corresponding to the first basic advertisement contents, wherein at least one of the plurality of first additional advertisement contents is applied continuously for providing a series of the first additional advertisement contents and the rest of the plurality of first additional advertisement contents are not applied continuously;
a first contents providing device that receives the plurality of basic advertisement contents and the plurality of first additional advertisement contents from the advertisement providing device, provides a stored first web page and the first basic advertisement contents to the user terminal, and provides the plurality of first additional advertisement contents to the user terminal in response to a user action on the first basic advertisement contents provided by the user terminal; and
a second contents providing device that receives the plurality of basic advertisement contents and the plurality of first additional advertisement contents from the advertisement providing device, provides a stored second web page and the second basic advertisement contents to the user terminal when the user terminal accesses from the first contents providing device, and provides the first additional advertisement contents continuously to the user terminal in response to a user action on the second basic advertisement contents, provided from the user terminal.

32. The advertisement providing system of claim 31, wherein the first contents providing device collects first action information on the user action received from the user terminal and provides the collected first action information to the advertisement providing device, the first action information including the number of exposures/clicks of the first basic advertisement contents and the number of exposures/clicks of the first additional advertisement contents, and the second contents providing device collects second action information for the user action received from the user terminal and provides the collected second action information to the advertisement providing device, the second action information including the number of exposures/clicks of the second basic advertisement contents and the number of exposures/clicks of the first additional advertisement contents.

33. The advertisement providing system of claim 32, wherein the advertisement providing device performs a billing process for respective advertisement providers of the first basic advertisement contents, the second basic advertisement contents, and the first additional advertisement contents based on the number of exposures/clicks of the first basic advertisement contents, the number of exposures/clicks of the second basic advertisement contents, and the number of exposures/clicks of the first additional advertisement contents which are included in the action information respectively received from the first and second contents providing devices, and the advertisement providing device performs a graded billing process for the advertisement provider of the first additional advertisement contents based on whether the first additional advertisement contents are continuously applied.

34. An advertisement providing method of a system that provides an advertisement to a user terminal, the advertisement providing method comprising:
receiving information on a plurality of first additional advertisement contents provided to the user terminal by a first contents providing device that provides contents, from the first contents providing device, wherein at least one of the plurality of first additional advertisement contents is applied continuously for providing a series of first additional advertisement contents and the rest are not applied continuously;
providing basic advertisement contents to the user terminal based on a plurality of stored first contents registration information that include the basic advertisement contents; and
providing the first additional advertisement contents which are continuously applied among the plurality of first additional advertisement contents when a user action for the basic advertisement contents provided from the user terminal is received.

35. The advertisement providing method of claim 34, further comprising:
after the providing of the basic advertisement contents to the user terminal, collecting action information on the user action, the action information including the number of exposures/clicks of the basic advertisement contents and the number of exposures/clicks of the first additional advertisement contents; and
transmitting the collected action information to a device that performs a billing process for billing the advertisement providers of the basic advertisement contents and the first additional advertisement contents when the user terminal terminates access.

36. The advertisement providing method of claim 34, wherein the providing of the first additional advertisement contents which are continuously applied among the plurality of first additional advertisement contents to the user terminal comprises providing the first additional advertisement contents which are continuously applied among the plurality of additional advertisement contents to the user terminal for displaying it in a pop-up form in response to the user action for the basic advertisement contents.

37. The advertisement providing method of claim 34, wherein the providing of the first additional advertisement contents which are continuously applied among the plurality of first additional advertisement contents to the user terminal comprises providing the first additional advertisement contents which are continuously applied among the plurality of additional advertisement contents to the user terminal for displaying it together with the basic advertisement contents in response to the user action for the basic advertisement contents.

38. An advertisement providing method of a system that provides an advertisement to a user terminal, the advertisement providing method comprising:
receiving information on a plurality of first advertisement contents provided to the user terminal by a first contents providing device that provides contents, from the first contents providing device, wherein at least one of the plurality of first advertisement contents is applied continuously for providing a series of the first advertisement contents and the rest are not applied continuously;
providing a web page in which first contents is included to the user terminal based on a plurality of stored first contents registration information, the first contents registration information including first contents that includes at least one of a word, an image, and a motion picture provided on the web page;
providing first advertisement contents which are continuously applied among the plurality of first advertisement contents to the user terminal when a user action on the first contents is received from the user terminal;
collecting action information on the user action, the user action information including the number of exposures/clicks of the first advertisement contents; and
transmitting the collected action information to a device that performs a billing process for billing an advertisement provider of the first advertisement contents when the user terminal terminates access.

39. The advertisement providing method of claim 38, wherein the providing of the first advertisement contents which are continuously applied among the plurality of first advertisement contents to the user terminal comprises providing the first advertisement contents which are continuously applied among the plurality of first advertisement contents to the user terminal for displaying it in a pop-up form in response to the user action on the first contents.

40. The advertisement providing method of claim 38, wherein the providing of the first advertisement contents which are continuously applied among the plurality of first advertisement contents to the user terminal comprises providing the first advertisement contents which are continuously applied among the plurality of first advertisement contents to the user terminal for displaying it together with the first contents in response to the user action.
